(19) United States
(12) Patent Application Publication
(10) Pub. No.: US 2026/0332513 A1
(43) Pub. Date: Oct. 22, 2026

(54) Managing Traffic-Engineered Paths in a Network using Dependency Graphs

(71) Applicant: Ciena Corporation, Hanover, MD (US)

(72) Inventors: Todd Defilippi, Redwood City, CA (US); Amal Karboubi, Ottawa (CA)

(73) Assignee: Ciena Corporation, Hanover, MD (US)

(21) Appl. No.: 19/182,709

(22) Filed: Apr. 18, 2025

(51) Int. Cl. H04L 45/18; H04L 45/50; H04L 45/586

(52) U.S. Cl. CPC H04L 45/18; H04L 45/50; H04L 45/586

(57) ABSTRACT

A method is disclosed for managing recomputation of traffic-engineered (TE) paths in a network. The method involves constructing a generic dependency graph representing TE paths and their dependencies. Upon detecting modifications to one or more TE paths, a recursive depth-first exploration of the dependency graph identifies all TE paths affected by these changes, creating a simplified dependency trace. This trace directly captures dependencies among TE paths, removing relationship details. The method processes this trace to generate an ordered recomputation list of TE paths, ensuring each path is recalculated only after its dependent paths. The framework readily supports new dependency types, such as policy grouping, diversity, disjointness, or co-routing, by simply defining new relationships and their traversal rules, enhancing scalability and reducing operational complexity.

### FIELD OF THE DISCLOSURE

The present disclosure relates generally to networking and computing. More particularly, the present disclosure relates to systems and methods for managing traffic-engineered (TE) paths in a communication network, including their recomputation, using dependency graphs.

### BACKGROUND OF THE DISCLOSURE

In traffic-engineered (TE) networks, path computation elements (PCEs) are employed to calculate and manage TE paths, enabling explicit control of traffic flow between endpoints rather than relying solely on default network routing behaviors. TE paths are explicitly defined routes through the network, each potentially subject to unique performance requirements, constraints, and policies. Within these networks, dependencies frequently arise between multiple TE paths. For instance, certain paths may require diversity, meaning they cannot share common network resources with other specific paths. Alternatively, some paths might serve as backups or secondary paths activated only if primary paths fail or become unavailable. When network conditions trigger the recomputation of a particular TE path—such as due to link failures, congestion, or changes in resource availability—this recalculation can impact other TE paths that depend on it. As a result, dependent TE paths may no longer meet their required constraints or policies due to changes in the initially recomputed path. Consequently, these secondary paths must also be recomputed to restore compliance with their specified requirements.

Current path computation solutions typically manage path dependencies based on a fixed, predefined set of dependency types (e.g., diversity, co-routing, or sequential backup paths). The interaction logic governing these dependencies is inherently limited, catering only to predetermined scenarios. Such an approach makes it challenging to incorporate new dependency types or to adapt the system flexibly as network requirements evolve. Each additional dependency type introduced may invalidate previous assumptions or logic, necessitating extensive changes to existing implementations. This situation commonly leads to increasingly complex implementations filled with special-case handling. As the number of supported dependency types increases, the complexity of managing interactions among them grows exponentially, making the system more cumbersome, error-prone, and costly to maintain and expand over time.

### BRIEF SUMMARY OF THE DISCLOSURE

The present disclosure describes systems and methods for efficiently managing traffic engineering (TE) paths, including their recomputation, using a generic dependency graph within a path computation element (PCE). The disclosed approach constructs a dependency graph representing TE paths as dependency elements and their interdependencies as dependency relationships, encapsulating behaviors unique to each dependency type, such as policy, diversity, virtual link, disjointness, or co-routing. Upon modification of one or more TE paths, the PCE recursively traverses the dependency graph according to predefined exploration rules, generating a simplified dependency trace that explicitly identifies all affected TE paths. This trace is subsequently processed to produce an ordered recomputation list, which provides that each TE path is recomputed only after all TE paths it directly depends on have been resolved. This generic and modular approach may: significantly enhance flexibility and extensibility, reduce the complexity associated with adding new dependency types, accelerate solution development, lower maintenance costs, and/or improve overall scalability and reliability.

In an embodiment, a method for managing recomputation of traffic-engineered (TE) paths in a network includes constructing a dependency graph comprising dependency elements corresponding to TE paths, including candidate paths of Segment Routing Traffic Engineering (SR-TE) policies or Label Switched Paths (LSPs) of Resource Reservation Protocol - Traffic Engineering (RSVP-TE) tunnels, and dependency relationships representing various types of dependencies among these elements. Dependency relationships include policy relationships among candidate paths within SR-TE policies, tunnel relationships among LSPs within RSVP-TE tunnels, virtual link relationships between virtual link consumer TE paths and virtual link producer TE paths, and diversity relationships between diversity target TE paths and diversity source TE paths. Responsive to modifications in one or more TE paths, the method involves recursively exploring the dependency graph using depth-first traversal according to specific exploration rules, generating a dependency trace consisting of trace elements corresponding directly to dependency elements with direct dependency connections. The dependency trace is processed by iteratively building an ordered recomputation list, ensuring each TE path is recomputed after its direct dependencies. When cyclic dependencies are detected, involved trace elements are grouped into a single group recomputation element. The method also supports defining and integrating new dependency relationships, such as diversity, co-routed, or path disjointness relationships, by specifying attachment and traversal rules, enabling existing logic to accommodate these new relationships without additional modifications.

In another embodiment, a path computation element (PCE) configured for managing recomputation of TE paths includes processors and memory storing instructions to perform the aforementioned method steps: constructing the dependency graph, performing recursive exploration, creating the dependency trace, generating and processing the ordered recomputation list, handling cyclic dependencies, and integrating newly defined dependency relationships. The PCE follows the defined exploration and processing logic to accommodate and manage diverse dependency relationships, ensuring efficient and accurate recomputation of TE paths within the network.

### BRIEF DESCRIPTION OF THE DRAWINGS

The present disclosure is illustrated and described with reference to the accompanying drawings. Unless otherwise specified, the drawings are not necessarily drawn to scale, and certain features or components may be enlarged, exaggerated, or omitted for clarity. Like reference numerals are used throughout to denote like components or steps, as appropriate.

FIG. 1 illustrates an example network with multiple network elements interconnected by various network links and managed by a path computation element (PCE).

FIG. 2 illustrates an example dependency graph for representing TE path dependencies within the network.

FIG. 3 illustrates a set of explorations in the dependency graph with trace elements associated with a dependency element from the dependency graph in FIG. 2.

FIG. 4 illustrates a resulting dependency trace from the explorations in FIG. 3.

FIG. 5 illustrates a flowchart of a process for managing recomputation of Traffic Engineering (TE) paths within a network.

FIG. 6 is a block diagram of a computing system that may be used to implement various components described in this disclosure.

FIG. 7 illustrates a block diagram of a network element, depicted in a simplified functional format.

The present disclosure describes the construction and use of a generic dependency graph to effectively manage traffic-engineered (TE) paths within a network. In this approach, various types of TE paths are represented as distinct dependency elements, and the specific dependencies among these TE paths—such as diversity, co-routing, disjointness, or sequential backup relationships—are represented as distinct dependency relationships. Each dependency element and relationship encapsulates its own behavior, facilitating modularity and substantially limiting complexity to the respective elements and relationships themselves. A generic traversal algorithm is then used to traverse this dependency graph, dynamically utilizing the behaviors defined by each dependency element and relationship, thus generating a comprehensive dependency trace. This dependency trace is subsequently processed in a similarly generic manner to yield an ordered computation list of TE paths, clearly defining the sequence in which paths are to be recomputed. By employing this methodology, the PCE can support a broader array of TE path configurations and dependency scenarios without requiring significant modifications for each new dependency type. Consequently, the PCE is capable of efficiently managing more diverse, complex network behaviors, enabling support for a wider range of customer network requirements while may result in significantly reducing the engineering effort, accelerating solution development, and lowering overall operational costs.

### TE Network

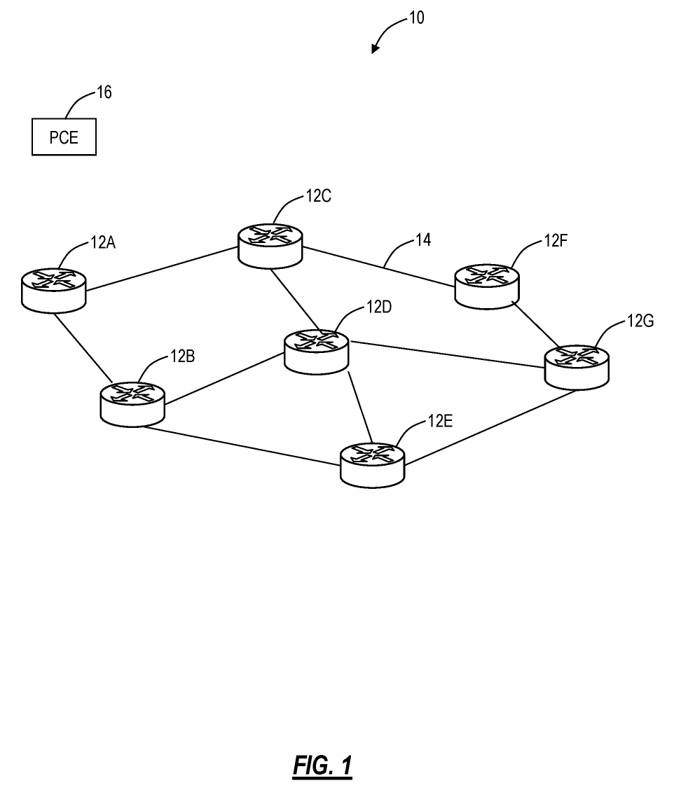

FIG. 1 illustrates an example network 10 with multiple network elements 12A–12G interconnected by various network links 14 and (e.g., centrally) managed by a PCE 16. In one embodiment, the network 10 implements a TE mechanism, such as Segment Routing Traffic Engineering (SR-TE), Resource Reservation Protocol—Traffic Engineering (RSVP-TE), or another suitable TE protocol. The network elements 12A–12G may represent switches, routers, optical cross-connects, or other suitable network infrastructure capable of forwarding traffic and executing TE decisions. Those skilled in the art will recognize that the disclosed methodologies are broadly applicable to path computation and management tasks within networks utilizing any TE-enabled protocol. Although Segment Routing (SR-TE) is specifically referenced here for illustrative purposes, the approach is not limited to SR-TE and applies equally well to other existing and future TE protocols.

The network 10 employs TE paths explicitly computed and managed by the PCE 16, allowing traffic to be directed optimally and deterministically between designated endpoints (e.g., from network element 12A to 12G), as opposed to relying solely on conventional shortest-path or default routing protocols. This explicit management capability enables efficient utilization of network resources, improved quality-of-service compliance, and adherence to specified network policies and constraints.

Certain TE paths may exhibit dependencies on other TE paths in various ways, reflecting specific network policies, constraints, or optimization goals. For instance, in SR-TE policies featuring restoration capabilities, multiple candidate paths are computed and organized according to preference rankings. Subsequent candidate paths within the SR-TE policy are typically only calculated or activated if earlier, higher-preference candidate paths fail, become unavailable, or if these subsequent paths operate in a standby or restoration mode. Each candidate path within the SR-TE policy represents a distinct TE path, individually computed and managed. Similarly, RSVP-TE tunnels are composed of Label Switched Paths (LSPs), each representing separate TE paths that are evaluated in a defined order, with backup or standby LSPs typically computed and provisioned based on the state or viability of primary LSPs.

Furthermore, certain TE paths (referred to as virtual link consumers) can explicitly utilize other TE paths (virtual link producers) as virtual links within their own paths. In this scenario, the virtual link producer is treated as a single hop or segment, analogous to traditional physical links, thus abstracting a potentially complex TE path into a manageable virtualized entity. For example, in SR-TE implementations, this may involve embedding the Binding Segment Identifier (BSID) associated with one SR-TE policy directly into the Segment Identifier (SID) list of another SR-TE policy.

Additionally, TE paths may have diversity dependencies, where a particular path (the diversity target) is required to maintain diversity from one or more other specified TE paths (the diversity sources). These diversity constraints typically dictate that the diversity target must utilize a completely separate set of network resources—such as distinct nodes, physical links, or shared-risk link groups (SRLGs)—from the diversity sources, ensuring robust network resiliency and preventing shared points of failure.

When a TE path undergoes recomputation due, for example, to network changes, other TE paths that depend on it may subsequently fail to meet their original constraints or performance requirements, necessitating their own recomputation to restore compliance. This dependency-driven recomputation process occurs in various ways:
(1) For SR-TE policies, if the status of an earlier (higher-preference) candidate path changes—such as transitioning from success to failure of computing, or vice versa—this directly impacts whether the PCE 16 should attempt to compute subsequent (lower-preference) candidate paths. For example, a previously inactive standby candidate path may require activation and recomputation if computation of the primary candidate path fails.
(2) Similarly, in RSVP-TE tunnels composed of multiple LSPs, the availability or viability of primary LSPs directly influences whether backup LSPs need to be recomputed. Failure of computation of a primary LSP triggers the recomputation of backup LSPs to ensure continued traffic flow through the network.
(3) In the case of virtual link consumers, if the TE path that acts as a virtual link producer undergoes changes—such as alterations in its routing or resource allocation—this can directly affect the ability of the virtual link consumer path to utilize it as originally computed. The PCE 16 will therefore need to recompute the virtual link consumer TE path to verify whether the virtual link remains viable or to find an alternative route that satisfies its constraints.
(4) Regarding diversity constraints, a TE path designated as a diversity target explicitly relies on having network resources distinct from one or more diversity source TE paths. If any changes occur in the diversity source paths—such as path rerouting or a shift in resource usage—the diversity requirements of the target path might no longer be satisfied. This mandates a recomputation of the diversity target path by the PCE 16 to ensure compliance with the diversity constraints (e.g., distinct nodes, links, or SRLGs).

These dependency effects can propagate through multiple layers of interconnected paths, creating a ripple effect throughout the network 10. As each dependent TE path undergoes recomputation, further dependent paths may subsequently require recalculation. This cascading impact requires the PCE 16 to maintain a clear and comprehensive understanding of the entire network dependency structure. Consequently, upon an initial network change affecting one or more TE paths, the PCE 16 must determine and track the complete set of TE paths ultimately needing recomputation. Moreover, the PCE 16 must establish a well-defined order for these recomputations, ensuring each TE path is recalculated only after all TE paths it directly depends upon have been successfully recomputed. Such ordered recomputation facilitates efficient path recalculations, consistent compliance with network policies, and rapid convergence to stable network conditions following changes. Following computation and recomputation, the PCE can direct other network elements to implement the TE paths. The PCE can further interact with network elements to obtain relevant data for directing its path recomputations.

### Framework

At a high level, an objective of the framework disclosed herein is to comprehensively manage TE path dependencies within PCE 16 by constructing and utilizing a generic dependency graph. The framework first tracks all TE paths configured within the PCE 16, considering their individual constraints, policies, and computed paths, to build this dependency graph. The graph includes dependency elements, each representing a computable TE path, and dependency relationships, each representing specific ways that TE paths relate to and depend upon one another, such as diversity, co-routing, virtual links, or sequential backup ordering.

When external events or network changes cause modifications in one or more TE paths, the PCE 16 leverages the constructed dependency graph to generate a dependency trace. This trace systematically identifies all TE paths that depend directly or indirectly on the initially modified paths. The dependency graph provides explicit instructions or other indications regarding which paths to include in this dependency trace and precisely outlines how each TE path within the trace is interconnected and reliant upon others.

With this dependency trace, the PCE 16 can then determine a proper recomputation ordering among all affected TE paths, ensuring consistency and correctness of recomputation processes. This ordered list of TE paths is provided to the PCE's 16 path computation module, establishing a clear and efficient sequence whereby a given TE path is always recomputed only after all the TE paths it depends upon have been resolved, recalculated, and stabilized. This mitigates the potential for multiple recomputations of a TE path.

An advantage of this framework is its inherent extensibility, allowing current dependency relationships to be modeled effectively while readily accommodating future dependency types in a generalized and flexible manner. The addition of new dependency types simply requires creating a new dependency relationship type with defined rules about how it integrates into the existing dependency graph. Beyond this specific definition, the framework operates generically, seamlessly incorporating the new dependency type into existing operations without requiring substantial changes.

The design of this framework facilitates that introducing new dependency types does not lead to exponential increases in complexity, as is commonly encountered in conventional implementations. Traditional approaches often require significant, complex, and error-prone modifications involving numerous special-case handling scenarios each time a new dependency type or relationship is introduced. In contrast, the present disclosure isolates the responsibility for managing detailed interactions between dependencies within each individual dependency relationship type. Each new dependency type encapsulates its own logic for attachment and traversal within the existing dependency graph structure, reducing or eliminating the need for widespread or invasive changes to the overall path computation logic. Consequently, the core framework itself remains stable, generic, and free from complex conditional branching that would otherwise arise from supporting a multitude of dependency scenarios.

### DEPENDENCY GRAPH

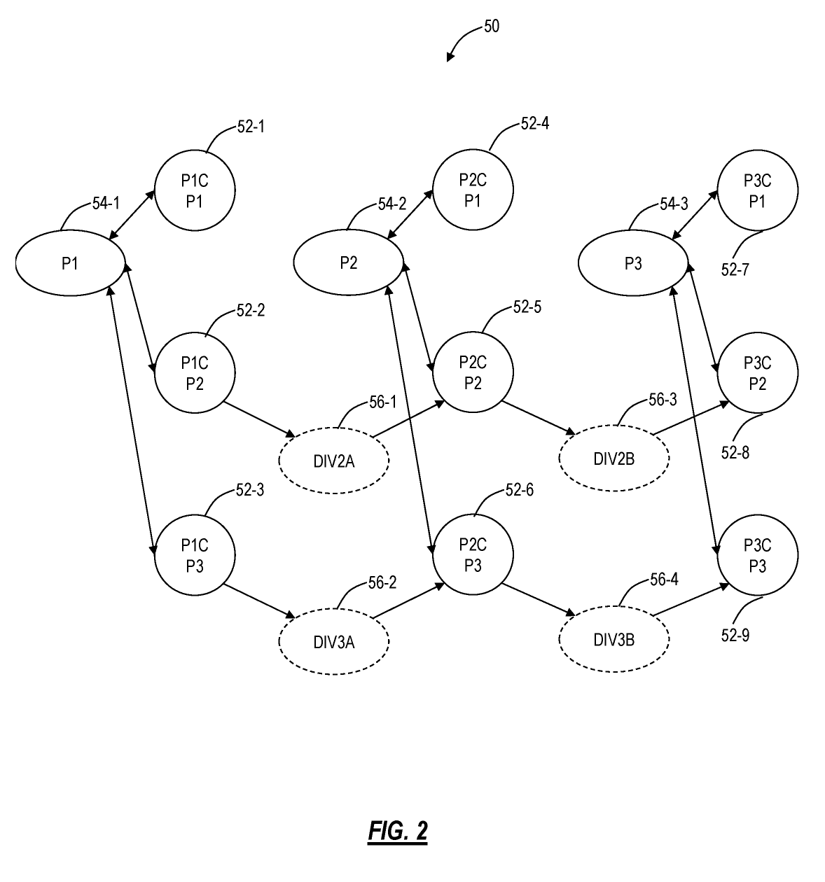

FIG. 2 illustrates an example dependency graph 50 for representing TE path dependencies within the network 10. The graph includes dependency elements 52-1 – 52-9 and dependency relationships 54-1, 54-2, 54-3, 56-1, 56-2, 56-3, 56-4, each representing computable TE paths and their associated dependencies. The dependency elements 52-1 – 52-9 represent individual computable TE paths, explicitly showing their roles in dependency relationships—either as TE paths upon which others depend or as TE paths dependent on others. The dependency elements 52-1 – 52-9 are represented as nodes or vertices in the graph 50 with edges to the dependency relationships 54, 56. Each dependency relationship 54, 56 are also nodes or vertices in the graphs with directed edges from the associated paths (represented by the dependency elements 52-1 – 52-9) used to represent an associated dependency.

For the dependency elements 52-1 – 52-9, in SR-TE, each represent a candidate path element, corresponding specifically to candidate paths within SR-TE policies. Each candidate path element has an attached policy relationship, clearly indicating its membership in an SR-TE policy. Candidate path elements may also have diversity relationships attached, wherein they serve either as diversity sources or diversity targets relative to other TE paths.

For the dependency elements 52-1 – 52-9, in RSVP-TE, each represents an LSP path element, corresponding to LSPs within RSVP-TE tunnels. Analogous to candidate path elements, each LSP path element will have an attached tunnel relationship, representing its association with a specific RSVP-TE tunnel. It may similarly include attached diversity relationships, identifying the LSP’s role in diversity dependencies as either source or target.

The dependency relationships 54, 56 explicitly represent how dependency elements 52-1 – 52-9 relate to and depend on each other. Relationships attach to dependency elements 52-1 – 52-9 (and potentially other relationships) to define the nature of these dependencies explicitly.

In this example, these relationships currently include:
(1) Policy Relationships (the dependency relationships 54-1, 54-2, 54-3), defining dependencies among candidate paths within a single SR-TE policy. Each policy relationship directly attaches to its corresponding candidate path elements 52. For example, the dependency relationship 54-1 is associated with TE paths (dependency elements) 52-1, 52-2 and 52-3. Policy relationships can also have attached diversity relationships, typically acting as a source when diversity involves an entire SR-TE policy rather than individual candidate paths.
(2) Tunnel Relationships (also represented as the dependency relationships 54-1, 54-2, 54-3, for RSVP-TE instead of SR-TE), operating similarly to policy relationships, but specifically managing dependencies among LSP path elements within RSVP-TE tunnels. Each tunnel relationship attaches directly to its associated LSP path elements 52 and may participate in attached diversity relationships similarly.
(3) Virtual Link Relationships, represented by the edges in the graph 50, explicitly defining dependencies between TE paths designated as virtual link producers and another TE path acting as the virtual link consumer. Each virtual link relationship attaches directly to the relevant dependency elements 52 of both the producer and consumer TE paths, clearly illustrating their virtual link dependency. Virtual Link Relationships represent dependencies between traffic-engineered (TE) paths, where one path (the virtual link consumer) explicitly utilizes another TE path (the virtual link producer) as an abstracted network segment. Within the disclosed dependency graph, these relationships are explicitly represented and modularly managed by connecting TE paths as dependency elements, clearly identifying consumer paths dependent upon producer paths. When a producer path changes, the dependency graph structure facilitates immediate identification and recursive exploration of all directly impacted consumer paths, creating a simplified dependency trace. This ensures that virtual link consumers are recomputed only after corresponding producers, efficiently maintaining compliance with network constraints and effectively handling complex virtual link dependencies.
(4) Diversity Relationships (the dependency relationships 56-1, 56-2, 56-3, 56-4) explicitly defining diversity constraints between a diversity target TE path and its designated diversity sources. Each diversity relationship attaches directly to the dependency element 52 representing its diversity target. Additionally, each diversity relationship attaches to the dependency elements 52 representing any diversity sources—these can be candidate paths or LSP path elements, or they may attach directly to policy or tunnel relationships when diversity dependencies involve entire SR-TE policies or RSVP-TE tunnels.

In FIG. 2, using SR-TE as an example, the illustrated scenario includes three distinct SR-TE policies (p1, p2, and p3, the dependency relationships 54-1, 54-2, 54-3), each containing three candidate paths, resulting in a total of nine candidate paths represented by the dependency elements 52-1 – 52-9. Each SR-TE policy is represented by a corresponding policy relationship shown in the dependency relationships 54-1, 54-2, 54-3, directly attached to their respective candidate path elements. Additionally, the graph shows four diversity relationships depicted as the dependency relationships 56-1, 56-2, 56-3, 56-4, explicitly illustrating diversity constraints among certain candidate paths. Through clear attachments to the candidate path dependency elements 52, these diversity relationships 54, 56 visually indicate precisely which candidate paths must remain diverse from each other, guiding the PCE’s recomputation logic to maintain consistent and compliant TE path computations.

As part of the extensibility of dependency graph 50, new dependency relationship types can be seamlessly integrated by simply introducing additional relationship node types into the graph structure. Beyond this limited addition, the fundamental dependency trace construction and traversal logic remain unchanged. Those skilled in the art will also recognize that the specific organizational structure of dependency graph 50 and dependency traces presented herein are illustrative examples; alternative organizational embodiments, graph layouts, and traversal sequences are contemplated and fall within the scope of the present disclosure.

In a dependency graph such as illustrated in FIG. 2, a dependency between two TE paths can be represented via a graph connection between the two nodes representing the two TE paths (dependency elements). The graph connection can include a single edge, which may be a directed edge. The graph connection can include two or more edges (which may be directed) and one or more intervening nodes, such as dependency relationship nodes. So, for example, the graph connection including node 56-1, along with its incoming and outgoing edges (represented as arrows) can represent a dependency relationship between TE paths 52-2 and 52-5. The direction of the edges can indicate which of the two TE paths depends on the other.

### Dependency Trace

The dependency graph 50 provides the PCE 16 with a structured model of TE path dependencies based on the existing set of TE paths managed within the PCE 16. However, when network changes or modifications occur to one or more TE paths, the PCE 16 must determine the comprehensive set of TE paths affected by this change that subsequently require recomputation, i.e., this is the use case of the dependency graph 50, namely to quickly and efficiency determine what TE paths are affected by a change to another TE path for recomputations. To achieve this, the PCE 16 constructs a dependency trace derived from the dependency graph 50.

The dependency trace is a streamlined representation containing trace elements, each directly corresponding to dependency elements 52 in the dependency graph 50. That is, like the dependency elements 52 in the dependency graph 50, the trace elements in the dependency trace represent TE paths. Importantly, this trace explicitly simplifies connections by only including depends-on and depended-on-by relationships between trace elements, i.e., the TE paths, thus abstracting away the detailed dependency relationship nodes (such as policy or diversity relationships). This simplified representation provides the PCE 16 exactly what it requires: a clear indication or understanding of how different TE paths relate directly to each other in terms of recomputation dependencies. The dependency trace can include the dependency elements 52 of the dependency graph, while excluding or abstracting the dependency relationships. For example, in the dependency trace, graph connections (paths) between dependency elements, which include one or more dependency relationships and two or more edges, can be replaced with a single graph edge.

To generate the dependency trace, the PCE 16 initially identifies all dependency elements 52 representing the TE paths immediately affected by network modifications, creating corresponding trace elements for these. Then, for each newly created trace element that has not yet been fully explored, the PCE 16 conducts a recursive, depth-first exploration process beginning from the corresponding dependency element 52 in the dependency graph 50.

During exploration, the PCE 16 follows rules to traverse attached relationships and subsequently the elements attached to those relationships:
(1) When exploration reaches another dependency element 52 (representing another TE path), the PCE 16 creates a new trace element (if one does not already exist), and establishes a depends-on or depended-on-by connection between this newly discovered trace element and the trace element from which the current exploration began. The dependency trace is another graph of dependency elements 52 (referred to as trace elements in the dependency trace) as nodes or vertices with directed edges representing depends-on or depended-on-by,
(2) If this latter trace element was newly created in the current exploration, it is queued for further processing.

This exploration continues recursively until all relevant trace elements and their dependencies have been discovered and established. Each exploration can generate relationship indications such as the dependency elements that depend on a given dependency element, or vice-versa.

Each dependency element 52 and relationship type in the graph includes explicit traversal rules:
(1) Candidate Path Elements explore their attached policy relationship as well as any attached diversity relationships where they are the source.
(2) LSP Path Elements similarly explore attached tunnel relationships and diversity relationships.

Each dependency relationship type defines unique traversal behavior:
(1) Policy Relationships identify the candidate path dependency element from which exploration originates, then explore the candidate path dependency element representing the subsequent candidate path within the same SR-TE policy (provided the current path is not the last in the policy). Additionally, they explore diversity relationships attached as sources.
(2) Tunnel Relationships similarly manage traversal between attached LSP dependency elements and associated diversity relationships.
(3) Virtual Link Relationships directly explore the attached virtual link consumer dependency element, establishing direct dependencies between virtual link producers and consumers.
(3) Diversity Relationships explore their attached diversity target dependency element, clearly defining dependencies arising from diversity constraints.

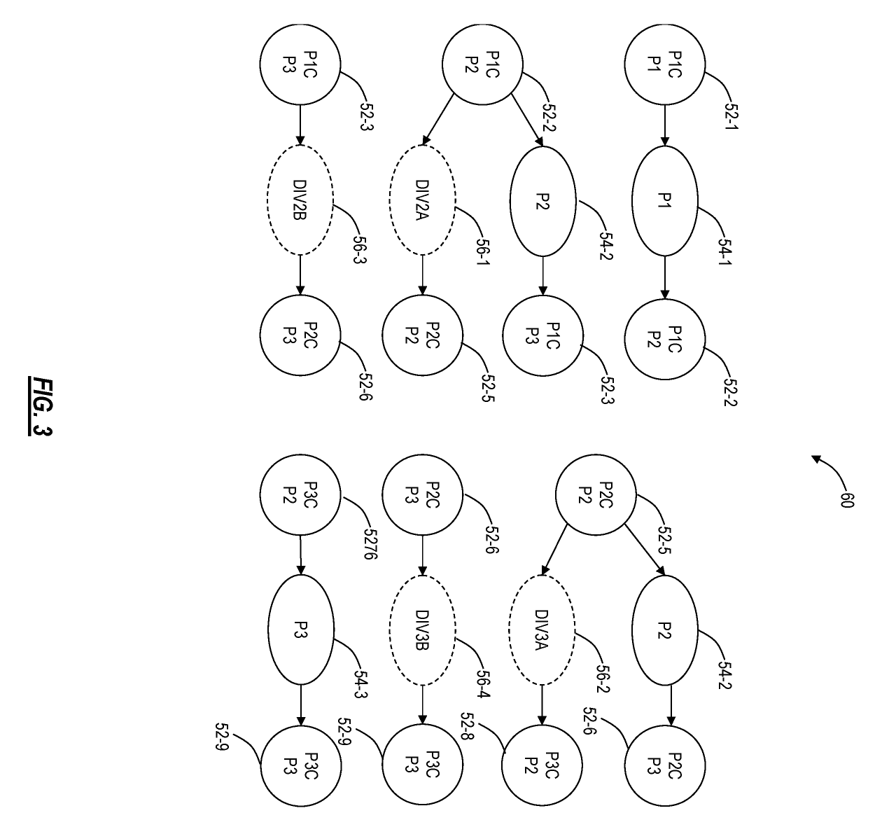

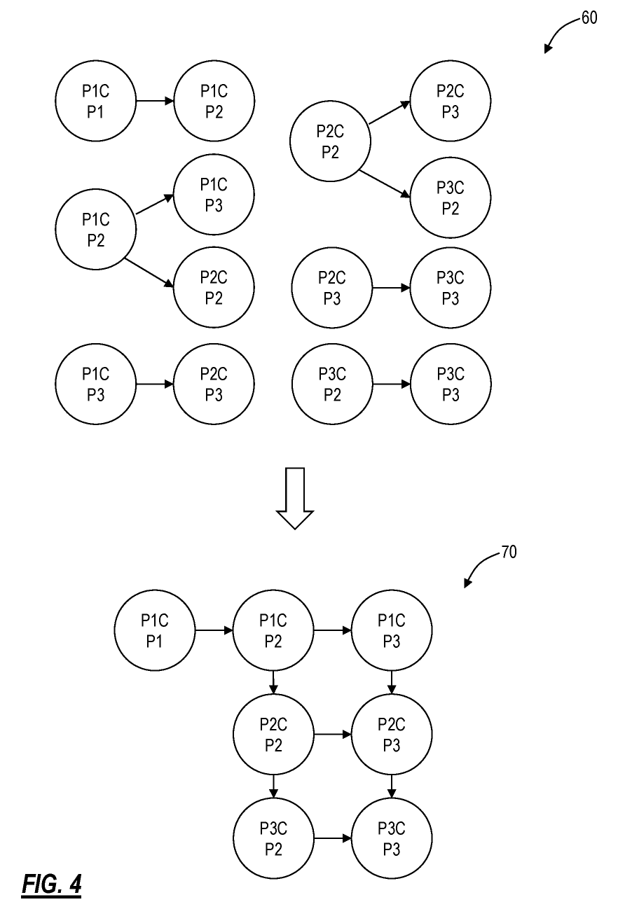

FIG. 3 illustrates a set of explorations 60 in the dependency graph 50 with trace elements associated with the dependency element 52-1. FIG. 4 illustrates a resulting dependency trace 70 from the explorations in FIG. 3. In FIG. 3, the explorations illustrate all of the dependency relationships 54, 56 starting with the dependency element 52-1. From the explorations in FIG. 3, FIG. 4 illustrates how the dependency graph 50 from the explorations 60 is simplified during the creation of the dependency trace 70. Initially, all dependency relationships 54, 56 are removed (top half of FIG. 4), leaving only direct candidate path elements and simplified dependency arrows that represent direct dependencies between TE paths. The top half of FIG. 4 shows isolated direct dependency relationships between candidate paths, and the arrow in FIG. 4 indicates the transformation into a consolidated dependency trace 70. The consolidated dependency trace 70 can be generated from the isolated direct dependency relationships 60 by chaining the relationships 60 together. The resulting dependency trace (bottom half of FIG. 4) provides a clear, straightforward view of recomputation dependencies directly between candidate paths. This trace 70 gives the PCE 16 an explicit, linearized recomputation ordering, allowing efficient and ordered recalculations that respect all original dependency constraints.

A goal of the PCE 16 is to generate an ordered list of TE path computations that accurately reflects and respects all identified dependencies. To achieve this, the PCE 16 begins by identifying any trace elements within the dependency trace 70 that do not depend on other trace elements. These trace elements can be recomputed first without violating any dependencies. Referring to the example provided in the FIGS. 2-4, such an initial candidate might be p1cp1, the dependency element 52-1, as it has no upstream dependencies when considered as a trace element for example as in FIGS. 3 or 4.

After adding these initial independent trace elements to the computation list, the PCE 16 then evaluates the remaining trace elements to identify those that either have no dependencies or whose dependencies have already been included in the computation list. Continuing the provided example, once p1cp1 is included, the next trace element satisfying this condition might be p1cp2, provided it depended only on p1cp1, which is now resolved. This iterative process continues systematically, adding each eligible trace element to the computation list in turn, until all trace elements in the dependency trace have been accounted for. By following this methodical approach, the PCE 16 constructs an ordered recomputation list that explicitly maintains all identified dependency constraints among the TE paths.

However, it is possible that certain dependencies within the dependency trace 70 may form a cyclic loop. Such a scenario complicates the linear ordering process described above, as no clear candidate will emerge for the next trace element to add to the computation list—each trace element within the loop will have unresolved dependencies on another element within that same loop.

In these cases, the PCE 16 framework recognizes that it cannot directly resolve such loops through simple ordering. Instead, it groups all trace elements involved in the dependency loop into a group recomputation element, adds this group recomputation element to the recomputation list, and processes each element of the recomputation list—including individual recomputation elements and group recomputation elements—using the computation module of the PCE 16 for special handling. The computation module is responsible for determining an appropriate method—such as iterative computations, simultaneous evaluations, or using heuristic resolution methods—to create a valid and compliant set of computations from these cyclic dependencies.

Thus, this dependency graph 50 framework's core responsibility includes identifying dependencies, constructing an accurate and ordered recomputation list, and explicitly recognizing when a dependency loop exists. Resolution of loops through alternative methods or specialized computation techniques is delegated to other dedicated modules within the PCE 16, preserving the generality and modularity of the dependency management process described herein.

While the dependency framework described above includes a set of commonly used dependency types—namely policy, tunnel, virtual link, and diversity—the architecture is specifically designed to accommodate additional dependency types seamlessly. The framework’s modular design ensures limited, minimal or no disruption to existing components, notably the PCE 16, when introducing new dependency relationships. To incorporate a new dependency type, the PCE 16 needs only to define a new dependency relationship type, explicitly specifying how it attaches to dependency elements and potentially other relationships, as well as how trace exploration traverses through that new relationship. Once introduced into the dependency graph, the new relationship automatically becomes part of the dependency trace exploration, helping the PCE accurately determine dependencies between trace elements and subsequently guiding the ordering of TE path recomputations.

Examples of possible additional relationships illustrating this flexibility include:
(1) PE Diversity Among SR-TE Policies: Users may define two distinct SR-TE policies across separate sets of endpoints, requiring specific levels of node, link, or SRLG diversity between these policies. To handle this scenario, a new "PE diversity" relationship can be defined, attaching explicitly to the two corresponding policy relationships. The trace exploration rules for this PE diversity relationship will specify a directed traversal from a designated "source" policy relationship to a "target" policy relationship. As a result, all candidate paths within the target SR-TE policy inherently depend on the successful computation of candidate paths within the source SR-TE policy. This clearly establishes the desired order of TE path computations.
(2) Bidirectional Co-routed SR-TE Policies: In scenarios where a user defines two SR-TE policies between the same endpoints but in opposite directions and wishes their computed paths to mirror each other exactly (i.e., be co-routed), the PCE can introduce a new "co-routed policy" relationship type. This co-routed policy relationship will directly attach to both policy relationships representing the two directional SR-TE policies. Since neither policy acts strictly as a dependency source or target, the exploration rules permit traversal in both directions, inherently creating bidirectional dependencies. As a result, a loop will emerge in the dependency trace. This loop scenario, as described previously, necessitates specialized handling by the computation module, separate from the dependency graph framework.

The above examples demonstrate that hierarchical relationships—such as policy groups or groups of policy groups—can be effortlessly built and layered within this framework. Traversal rules through hierarchical relationships define clear dependency orderings among higher-level entities (e.g., entire policy groups) and propagate this ordering recursively down to constituent dependency elements. This structured, hierarchical approach enables clear, maintainable, and intuitive definitions of dependencies within complex network configurations, significantly enhancing the PCE’s ability to handle a diverse array of dependency scenarios.

Path disjointness, as defined in RFC 8800, “Path Computation Element Communication Protocol (PCEP) Extension for Label Switched Path (LSP) Diversity Constraint Signaling,” July 2020, the contents of which are incorporated by reference, shares similarities with the diversity requirements previously described, but differs fundamentally in its flexibility and ordering implications. Specifically, diversity requirements define dependencies from the perspective of a single diversity target TE path, inherently enforcing a directional ordering. In contrast, path disjointness defines dependencies among a group of TE paths without imposing strict directional ordering constraints, thereby providing more flexibility regarding how paths remain distinct from one another. Without the present framework, supporting disjointness would typically require extensive re-engineering of existing diversity logic within the PCE. However, with this framework, a new "disjointness relationship" type can easily be defined. This disjointness relationship encapsulates its own attachment logic to relevant dependency elements and relationships and explicitly dictates its exploration behavior during dependency trace traversal. It is important to note, however, that the inherent lack of directional ordering within disjointness groups can result in a fully meshed dependency loop among all included TE paths. This looped dependency structure, as described previously, requires specialized group-based computation handling by the computation module outside of the immediate scope of this dependency graph framework.

Thus, this framework's design inherently simplifies adding new dependency types, provides clear modularity, and significantly enhances scalability. Its generic yet powerful approach effectively minimizes development complexity, reduces implementation overhead, and accelerates integration of diverse dependency scenarios into existing network management processes.

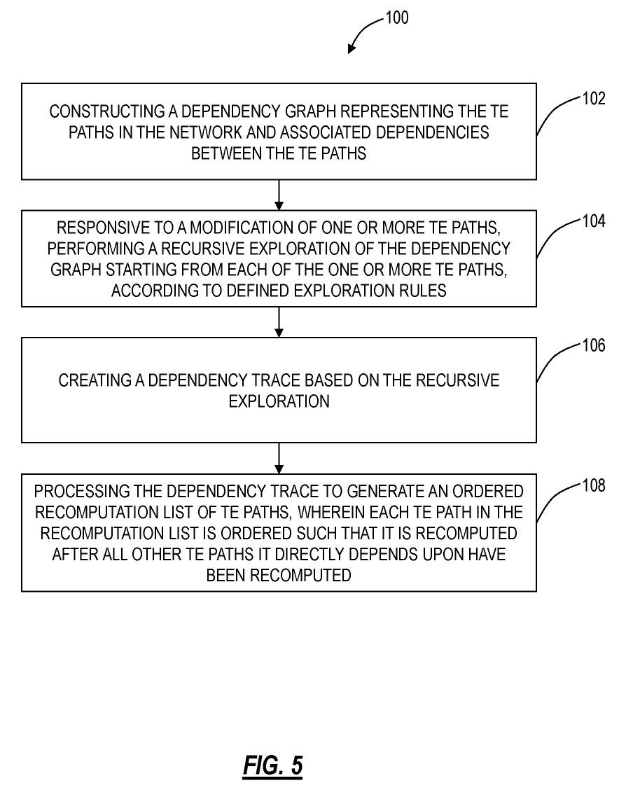

FIG. 5 illustrates a flowchart of a process 100 for managing recomputation of Traffic Engineering (TE) paths within a network. The process 100 can be implemented as a method including a series of steps executed by a processor or dedicated circuitry configured to perform the method steps, or as instructions stored on a non-transitory computer-readable medium that, when executed by a processor or other suitable circuitry, cause the circuitry to perform the method steps described herein.

The steps in the process 100 include constructing a dependency graph representing the TE paths in the network and associated dependencies between the TE paths (step 102); responsive to a modification of one or more TE paths, performing a recursive exploration of the dependency graph starting from each of the one or more TE paths, according to defined exploration rules (step 104); creating a dependency trace based on the recursive exploration (step 106); and processing the dependency trace to generate an ordered recomputation list of TE paths, wherein each TE path in the recomputation list is ordered such that it is recomputed after all other TE paths it directly depends upon have been recomputed (step 108).

The constructing the dependency graph can include creating dependency elements corresponding to the TE paths; and creating dependency relationships corresponding to types of dependencies among the dependency elements. Each dependency element can correspond to one of a candidate path of a Segment Routing Traffic Engineering (SR-TE) policy; or a Label Switched Path (LSP) of a Resource Reservation Protocol - Traffic Engineering (RSVP-TE) tunnel. Each dependency relationship can corresponds to one or more of a policy relationship defining dependencies among candidate paths within a Segment Routing Traffic Engineering (SR-TE) policy; a tunnel relationship defining dependencies among Label Switched Paths (LSP) within a Resource Reservation Protocol - Traffic Engineering (RSVP-TE) tunnel; a virtual link relationship defining a dependency of a virtual link consumer TE path on one or more virtual link producer TE paths; or a diversity relationship defining a dependency between a diversity target TE path and one or more diversity source TE paths.

The performing the recursive exploration can include a depth-first traversal according to the defined exploration rules specific to dependency elements and dependency relationships. The creating the dependency trace can include generating trace elements each corresponding directly to dependency elements in the dependency graph; and removing dependency relationships from the dependency graph to leave only direct dependency connections between the trace elements. The processing the dependency trace to generate the ordered recomputation list can include identifying an initial set of trace elements having no unresolved dependencies and adding the initial set to the recomputation list; iteratively adding trace elements to the recomputation list, each added trace element having either no dependencies or dependencies only on trace elements already included in the recomputation list; and continuing the iterative addition until all trace elements are included in the recomputation list.

The process 100 can further include detecting loops within the dependency trace when no eligible trace element remains for addition to the recomputation list due to cyclic dependencies; grouping all trace elements involved in a detected loop into group recomputation elements; adding the group recomputation elements to the recomputation list; and processing each element from the recomputation list, including individual recomputation elements and group recomputation elements. The process 100 can further include defining new dependency relationships by specifying attachment and traversal rules; and integrating the new dependency relationships into the existing dependency graph, enabling the dependency trace exploration and recomputation list processing to handle the new dependency relationships without modification to existing exploration and processing logic. The defining new dependency relationships can include defining one or more of a diversity relationship between distinct SR-TE policies to ensure node, link, or shared risk link group (SRLG) diversity; a co-routed relationship between bidirectional SR-TE policies to ensure symmetric path computation; or a path disjointness relationship to define dependencies among a group of TE paths without imposing strict directional ordering constraints.

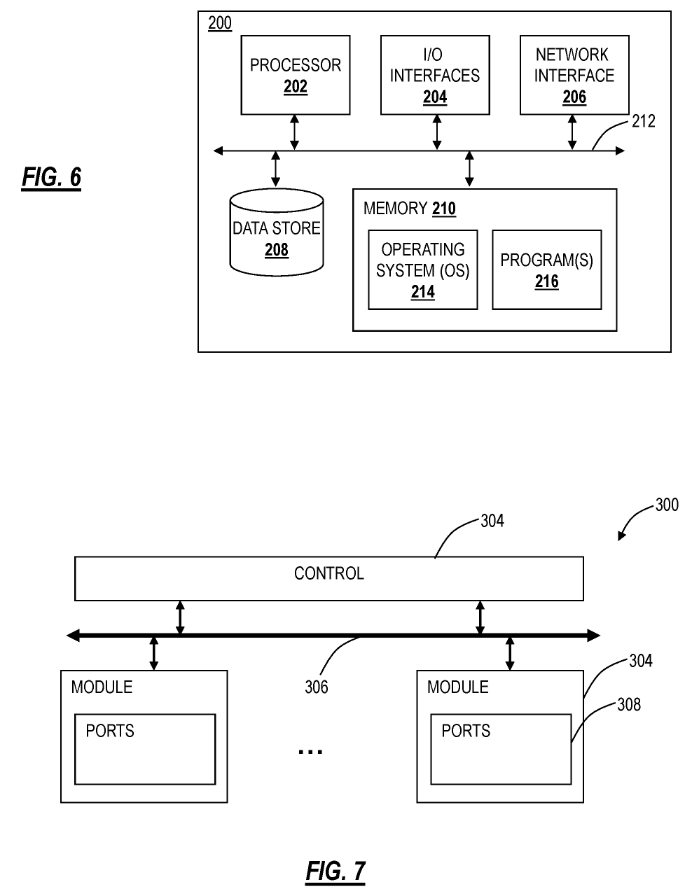

FIG. 6 is a block diagram of a computing system 200 that may be used to implement various components described in this disclosure, including the PCE 16. The computing system bcan be implemented in many forms, including laptops, desktops, physical servers, clusters of machines, virtual machines (VMs) running on hypervisors, or serverless computing frameworks. Regardless of the underlying infrastructure, the computing system 200 typically includes one or more processors 202, input/output (I/O) interfaces 204, a network interface 206, a data store 208, and memory 210. Note that FIG. 6 provides a simplified representation; in practice, the computing system 200 may include additional hardware and software elements. These components 202, 204, 206, 208, 210 are connected via a local interface 212, which can include various wired or wireless buses, high-speed interconnects, or switching fabrics. The local interface 212 may also include controllers, buffers, caches, drivers, repeaters, and receivers, along with addressing and control lines that facilitate efficient communication and resource sharing among components.

Each processor 202 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 202 retrieves and executes instructions stored in memory 210, manages data exchanges with the data store 208, and oversees system 200 operations. In large-scale environments, multiple processors 202 may operate in parallel to handle elevated traffic and complex workloads.

The I/O interfaces 204 enable the computing system 200 to interact with external peripherals, allowing user input (e.g., via keyboards, touchscreens, or sensors) and system output (e.g., to displays or printers). Depending on the application, these I/O interfaces 204 may also support specialized devices used for maintenance, debugging, or other administrative functions. Meanwhile, the network interface 206 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 206 can remain protected, enabling the computing system 200 to participate safely in distributed or cloud-based deployments.

The data store 208 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 208 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 208 can hold operational logs, configuration details, policy rules, program binaries, and cached computation results.

The memory 210 typically serves as the primary working memory for the processors 202. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 210 can be distributed across nodes or servers to support the large-scale in-memory processing demanded by modern cloud services. Generally, the memory 210 stores the operating system (O/S) 214 and one or more programs 216. The O/S 214 handles core system tasks such as process scheduling, memory allocation, file management, and networking.

For Software-as-a-Service (SaaS) or other cloud-based components, the computing system 200 can be deployed in various ways: as a private cloud in a single organization’s datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

FIG. 7 illustrates a block diagram of a network element 300, depicted in a simplified functional format. It is important to note that a more practical design of this router would likely include additional components and processing logic to accommodate standard operating features, which are not detailed here. The network element 300 may represent any network element operable in a network using optical and packet protocols, such as including support for TE paths in the network 10, and includes various interconnected modules, such as modules 304, 304, via an interface 306, such as a backplane, midplane, cabling, etc. These modules, also known as blades or line cards, are typically mounted on the chassis. Each module 304, 306 can house numerous electronic or optical devices on a circuit board, complete with various interconnects, including interfaces to the chassis itself.

Specifically, the diagram illustrates two types of modules: line modules 300, which feature multiple ports 308 for external connections, and a control module 304. The line modules 302 facilitate data traffic switching between ports 308 via a switching fabric, which can be integrated across the modules 302, potentially centralized in a separate unit or module (not shown), as well as a combination. This switching fabric includes hardware, software, and firmware that routes data between the ports 308. The control module 304 is equipped with processing circuity, memory, software, and a network interface to manage operations such as configuration and monitoring of the network element 300. It may also communicate with external network management systems or databases that handle provisioning and operational data.

Lastly, while FIG. 7 provides a basic view, those skilled in the art will understand that the network element 300 could include additional components or be configured differently, such as in a distributed arrangement or as an integrated, rack-mounted unit (often referred to as a "pizza-box" configuration). This depiction in FIG. 7 is intended to convey functional aspects, with actual hardware implementations varying widely. In an embodiment, the network element 300 can be any of the network elements 12 in the network 10. Also, in another embodiment, the network element 300 can implement the process 100 and the like, such as where the PCE 16 is integrated within the network element 300.

The present disclosure provides a specific practical application in network traffic engineering (TE) by employing a dependency graph structure to effectively manage recomputation of TE paths within communication networks. Existing methods rely heavily on predefined, rigid dependency management, complicating system expansion and maintenance. In contrast, the disclosed approach practically improves management of TE paths by dynamically determining all affected paths upon network changes, automatically generating an ordered recomputation list ensuring each path is recalculated only after its dependent paths are resolved, thereby avoiding redundant computations and ensuring efficient network operation. The approach described herein achieves significant technical improvement by enhancing network performance, scalability, flexibility, and reliability. Specifically, it eliminates complex, hard-coded logic common in conventional approaches, encapsulating individual TE paths and interdependencies into modular dependency elements and relationships. This modular structure significantly reduces complexity and resource demands when adapting to new dependency types or evolving network conditions. Recursive graph traversal algorithms and simplified dependency traces further optimize recomputation processes, substantially decreasing processing overhead and rapidly stabilizing network states after disruptions. Unlike traditional methods requiring extensive re-engineering for new dependency types, this flexible architecture simplifies the integration of diverse dependencies—such as policies, tunnels, diversity constraints, and virtual links—into a unified structure, enabling network systems to efficiently adapt and scale, thereby overcoming persistent technical challenges in managing advanced communication networks.

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps—even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement—whether collectively, separately, or in subsets—thereby broadening the range of potential embodiments.

What is claimed is:

1. A method for managing recomputation of traffic-engineered (TE) paths in a network, comprising:
constructing a dependency graph representing the TE paths in the network and associated dependencies between the TE paths;
responsive to a modification of one or more TE paths, performing a recursive exploration of the dependency graph starting from each of the one or more TE paths, according to defined exploration rules;
creating a dependency trace based on the recursive exploration; and
processing the dependency trace to generate an ordered recomputation list of TE paths, wherein each TE path in the recomputation list is ordered such that it is recomputed after all other TE paths it directly depends upon have been recomputed.

2. The method of claim 1, wherein the constructing the dependency graph includes
creating dependency elements corresponding to the TE paths; and
creating dependency relationships corresponding to types of dependencies among the dependency elements.

3. The method of claim 2, wherein each dependency element corresponds to one of
a candidate path of a Segment Routing Traffic Engineering (SR-TE) policy; or
a Label Switched Path (LSP) of a Resource Reservation Protocol - Traffic Engineering (RSVP-TE) tunnel.

4. The method of claim 2, wherein each dependency relationship corresponds to one or more of
a policy relationship defining dependencies among candidate paths within a Segment Routing Traffic Engineering (SR-TE) policy;
a tunnel relationship defining dependencies among Label Switched Paths (LSP) within a Resource Reservation Protocol - Traffic Engineering (RSVP-TE) tunnel;
a virtual link relationship defining a dependency of a virtual link consumer TE path on one or more virtual link producer TE paths; or
a diversity relationship defining a dependency between a diversity target TE path and one or more diversity source TE paths.

5. The method of claim 1, wherein the performing the recursive exploration includes depth-first traversal according to the defined exploration rules specific to dependency elements and dependency relationships.

6. The method of claim 1, wherein the creating the dependency trace includes
generating trace elements each corresponding directly to dependency elements in the dependency graph; and
removing dependency relationships from the dependency graph to leave only direct dependency connections between the trace elements.

7. The method of claim 1, wherein the processing the dependency trace to generate the ordered recomputation list includes
identifying an initial set of trace elements having no unresolved dependencies and adding the initial set to the recomputation list;
iteratively adding trace elements to the recomputation list, each added trace element having either no dependencies or dependencies only on trace elements already included in the recomputation list; and
continuing the iteratively adding until all trace elements are included in the recomputation list.

8. The method of claim 7, further comprising
detecting loops within the dependency trace when no eligible trace element remains for addition to the recomputation list due to cyclic dependencies;
grouping all trace elements involved in a detected loop into a group recomputation element;
adding the group recomputation element to the recomputation list; and
processing each element from the recomputation list, including individual recomputation elements and group recomputation elements.

9. The method of claim 1, further comprising
defining new dependency relationships by specifying attachment and traversal rules; and
integrating the new dependency relationships into the dependency graph, enabling the dependency trace exploration and recomputation list processing to handle the new dependency relationships without modification to existing exploration and processing logic.

10. The method of claim 9, wherein the defining new dependency relationships includes defining one or more of
a diversity relationship between distinct SR-TE policies to ensure node, link, or shared risk link group (SRLG) diversity;
a co-routed relationship between bidirectional SR-TE policies to ensure symmetric path computation; or
a path disjointness relationship to define dependencies among a group of TE paths without imposing strict directional ordering constraints.

11. A path computation element (PCE) configured to manage recomputation of traffic-engineered (TE) paths in a network, the PCE comprising:
one or more processors and memory storing instructions that, when executed, cause the one or more processors to
construct a dependency graph representing the TE paths in the network and associated dependencies between the TE paths;
responsive to a modification of one or more TE paths, perform a recursive exploration of the dependency graph starting from each of the one or more TE paths, according to defined exploration rules;
create a dependency trace based on the recursive exploration; and
process the dependency trace to generate an ordered recomputation list of TE paths, wherein each TE path in the recomputation list is ordered such that it is recomputed after all other TE paths it directly depends upon have been recomputed.

12. The PCE of claim 11, wherein the dependency graph is constructed by
creating dependency elements corresponding to the TE paths; and
creating dependency relationships corresponding to types of dependencies among the dependency elements.

13. The PCE of claim 12, wherein each dependency element corresponds to one of
a candidate path of a Segment Routing Traffic Engineering (SR-TE) policy; or
a Label Switched Path (LSP) of a Resource Reservation Protocol - Traffic Engineering (RSVP-TE) tunnel.

14. The PCE of claim 12, wherein each dependency relationship corresponds to one or more of
a policy relationship defining dependencies among candidate paths within a Segment Routing Traffic Engineering (SR-TE) policy;
a tunnel relationship defining dependencies among Label Switched Paths (LSP) within a Resource Reservation Protocol - Traffic Engineering (RSVP-TE) tunnel;
a virtual link relationship defining a dependency of a virtual link consumer TE path on one or more virtual link producer TE paths; or
a diversity relationship defining a dependency between a diversity target TE path and one or more diversity source TE paths.

15. The PCE of claim 11, wherein the recursive exploration includes a depth-first traversal according to the defined exploration rules specific to dependency elements and dependency relationships.

16. The PCE of claim 11, wherein the dependency trace is created by
generating trace elements each corresponding directly to dependency elements in the dependency graph; and
removing dependency relationships from the dependency graph to leave only direct dependency connections between the trace elements.

17. The PCE of claim 11, wherein the dependency trace is processed to generate the ordered recomputation list by
identifying an initial set of trace elements having no unresolved dependencies and adding the initial set to the recomputation list;
iteratively adding trace elements to the recomputation list, each added trace element having either no dependencies or dependencies only on trace elements already included in the recomputation list; and
continuing the iteratively adding until all trace elements are included in the recomputation list.

18. The PCE of claim 11, wherein the memory storing instructions that, when executed, further cause the one or more processors to
detect loops within the dependency trace when no eligible trace element remains for addition to the recomputation list due to cyclic dependencies;
group all trace elements involved in a detected loop into a group recomputation element;
add the group recomputation element to the recomputation list; and
process each element from the recomputation list, including individual recomputation elements and group recomputation elements.

19. The PCE of claim 11, wherein the memory storing instructions that, when executed, further cause the one or more processors to
define new dependency relationships by specifying attachment and traversal rules; and
integrate the new dependency relationships into the dependency graph, enabling the dependency trace exploration and recomputation list processing to handle the new dependency relationships without modification to existing exploration and processing logic.

20. The PCE of claim 19, wherein defining new dependency relationships includes defining one or more of
a diversity relationship between distinct SR-TE policies to ensure node, link, or shared risk link group (SRLG) diversity;
a co-routed relationship between bidirectional SR-TE policies to ensure symmetric path computation; or
a path disjointness relationship to define dependencies among a group of TE paths without imposing strict directional ordering constraints.
